(19) United States
(12) Patent Application Publication
(10) Pub. No.: US 2018/0320865 A1
(43) Pub. Date: Nov. 8, 2018

(54) BULB CHANGER

(71) Applicant: Hyeong Du HAN, Chungcheongnam-do (KR)

(72) Inventor: Hyeong Du HAN, Chungcheongnam-do (KR)

(21) Appl. No.: 15/542,101

(22) PCT Filed: Dec. 24, 2015
(86) PCT No.: PCT/KR2015/014228

§ 371 Date: Jun. 29, 2018

(30) Foreign Application Priority Data
Jan. 7, 2015 (KR) 20-2015-0000123

(51) Int. Cl. F21V 19/04

(52) U.S. Cl. CPC F21V 19/04; B25G 1/043

(57) ABSTRACT

A bulb changer according to the present invention is advantageous in that when a bulb having glass tubes with gaps therebetween is replaced, protrusions of a bulb insertion portion is inserted into the gaps of the bulb, such that the bulb is integrally fixed to the bulb insertion portion and then separated by being rotated, and as a result, it is possible to prevent withdrawal or swaying of the bulb when replacing the bulb. Therefore, a bulb positioned at a high place such as a ceiling may be advantageously replaced more easily and conveniently.

### TECHNICAL FIELD

The present invention relates to a bulb changer, and more particularly, to a bulb changer capable of enabling a user to easily and safely replace a bulb installed on the ceiling.

### BACKGROUND ART

In general, when a bulb reaches the end of its life after being used over a predetermined period of time, the bulb needs to be replaced. The bulb, which is installed at a comparatively low place within arm reach, can be easily replaced without a separate tool, but in a case in which the bulb is installed on a ceiling of a factory, a building, or a waiting room, separate equipment such as a ladder is required to replace the bulb. The process of replacing the bulb installed on the ceiling by using the ladder and the like is a very laborious and dangerous task.

### DISCLOSURE

### Technical Problem

An object of the present invention is to provide a bulb changer capable of enabling a user to more safely replace a bulb installed at a high place such as a ceiling.

### Technical Solution

The present invention provides a bulb changer for replacing a bulb which is installed on a ceiling and has a plurality of glass tubes with gaps therebetween, the bulb changer including: a bulb insertion portion which is formed in a container shape opened at an upper side thereof so that the bulb is inserted into the bulb insertion portion, in which the bulb insertion portion has protrusions that protrude to be inserted into the gaps of the bulb; and a handle portion which is connected to a lower portion of the bulb insertion portion and elongated in an up and down direction so that a user holds and rotates the handle portion.

### Advantageous Effects

The bulb changer according to the present invention is advantageous in enabling the user to more easily and conveniently replace the bulb which is positioned at a high place such as a ceiling and has the glass tubes with the gaps therebetween.

In addition, the bulb changer according to the present invention is advantageous in that the protrusion of the bulb insertion portion is inserted into the gap of the bulb, and the bulb is integrally fixed to the bulb insertion portion and then separated by being rotated, and as a result, it is possible to prevent withdrawal or swaying of the bulb when replacing the bulb.

In addition, the bulb changer according to the present invention is advantageous in that since the structure of the bulb changer is comparatively simple, the bulb changer is easily manufactured, and manufacturing costs are reduced.

In addition, the bulb changer according to the present invention is advantageous in that since the protrusion, which is made of an elastic member, is coupled to the slit hole of the bulb insertion portion, damage to the bulb is prevented and the protrusion may be easily inserted into the gap of the bulb when the protrusion is inserted into the gap of the bulb.

### DESCRIPTION OF DRAWINGS

FIG. 1 is a view illustrating a bulb and a bulb changer according to a first exemplary embodiment of the present invention.

FIG. 2 is a view illustrating a state in which the bulb and the bulb changer illustrated in FIG. 1 are coupled to each other.

FIG. 3 is a cross-sectional view taken along line A-A of FIG. 2.

FIG. 4 is a view illustrating a bulb changer according to a second exemplary embodiment of the present invention.

FIG. 5 is a cross-sectional view of the bulb changer illustrated in FIG. 4.

FIG. 6 is a view illustrating a bulb and a bulb changer according to a third exemplary embodiment of the present invention.

FIG. 7 is a cross-sectional view of the bulb changer illustrated in FIG. 6.

FIG. 8 is a view illustrating a bulb changer according to a fourth exemplary embodiment of the present invention.

### MODES OF THE INVENTION

Hereinafter, exemplary embodiments of the present invention will be described in detail with reference to the accompanying drawings.

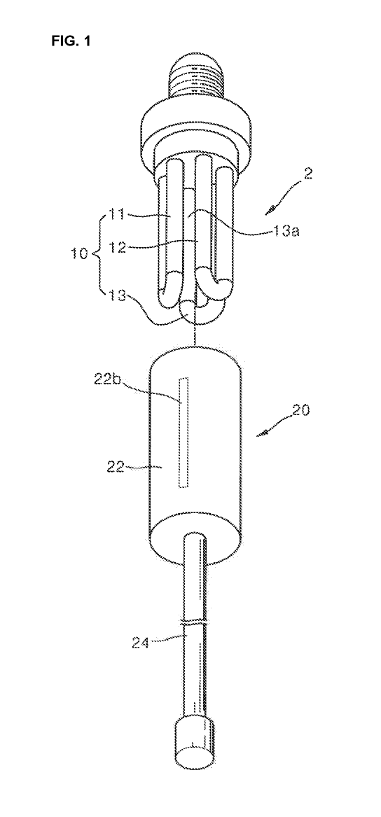

Referring to FIGS. 1 and 2, a bulb changer 20 according to a first exemplary embodiment of the present invention is a tool used to replace a bulb 2 installed at a high place such as a ceiling.

The bulb 2 includes a plurality of glass tubes 10, and the plurality of glass tubes 10 is disposed to be spaced apart from each other at a predetermined interval such that gaps 13a are formed between the plurality of glass tubes 10. The gap 13a is elongated in an up and down direction.

The present exemplary embodiment describes an example in which the bulb 2 has three glass tubes, that is, first, second, and third glass tubes 11, 12, and 13 formed to be bent in a U shape, and the bulb 2 is a 3-tube bulb in which the first, second, and third glass tubes 11, 12, and 13 are disposed in a triangular shape.

Therefore, in the case in which the bulb 2 is the 3-tube bulb, the three gaps 13a are formed between the three glass tubes, that is, the first, second, and third glass tubes 11, 12, and 13.

However, the present invention is not limited thereto, and the bulb 2 may of course have two or less glass tubes or four or more glass tubes. The bulb 2 is coupled to a socket by a threaded engagement, such that the bulb 2 is separated from the socket when the bulb 2 is rotated counterclockwise, and the bulb 2 is coupled to the socket when the bulb 2 is rotated clockwise.

The bulb changer 20 includes a bulb insertion portion 22 and a handle portion 24.

The bulb insertion portion 22 is formed in a container shape opened at an upper side thereof so that the bulb 2 is inserted into the bulb insertion portion 22. A cross-sectional area of the bulb insertion portion 22 is increased upward toward the bulb 2 so that the bulb 2 is easily inserted into the bulb insertion portion 22.

However, the present invention is not limited thereto, and the bulb insertion portion 22 may be formed in a cylindrical shape having a constant cross-sectional area. An example in which the bulb insertion portion 22 is made of a plastic material will be described.

The bulb insertion portion 22 includes protrusions 22a that protrude to be inserted into the gaps 13a of the bulb 2.

The protrusions 22a are formed integrally with the bulb insertion portion 22. The protrusions 22a protrude inward from an inner surface of the bulb insertion portion 22, and the protrusions 22a are elongated in the up and down direction so as to correspond to the shapes of the gap 13a. The plurality of protrusions 22a is provided on the inner surface of the bulb insertion portion 22 so as to be spaced apart from one another at predetermined intervals in a circumferential direction. The protrusions 22a may be formed to be inserted into only some of the three gaps 13a or all of the three gaps 13a.

In the present exemplary embodiment, an example in which the protrusions 22a are inserted into all of the three gaps 13a will be described.

The three protrusions 22a are provided to correspond to the number of gaps 13a of the bulb 2.

That is, an example in which a total of three protrusions 22a are formed on the inner surface of the bulb insertion portion 22 so as to be spaced apart from one another at an interval of 120 degrees in the circumferential direction will be described.

However, the present invention is not limited thereto, and in the case in which the protrusions 22a are inserted into only some of the three gaps 13a, the number of protrusions 22a is smaller than the number of gaps 13a.

A guide line 22b is marked on an outer surface of the bulb insertion portion 22 in order to inform a user of a position of the protrusion 22a. With the guide line 22b, the user easily matches the position of the protrusion 22a with a position of the gap 13a.

The handle portion 24 is connected to a lower portion of the bulb insertion portion 22, and the handle portion 24 is formed such that the user may hold and rotate the handle portion 24. The handle portion 24 is formed in the form of a bar elongated in the up and down direction. The handle portion 24 may of course be formed to be adjustable in length.

The bulb changer of the present invention, which is configured as described above, is used as follows.

First, the bulb insertion portion 22 is positioned below the bulb 2 installed at a high place such as a ceiling, and then the handle portion 24 is lifted up to move the bulb insertion portion 22 upward. In this case, the position of the protrusion 22a is aligned with the position of the gap 13a, and then the bulb insertion portion 22 is moved upward.

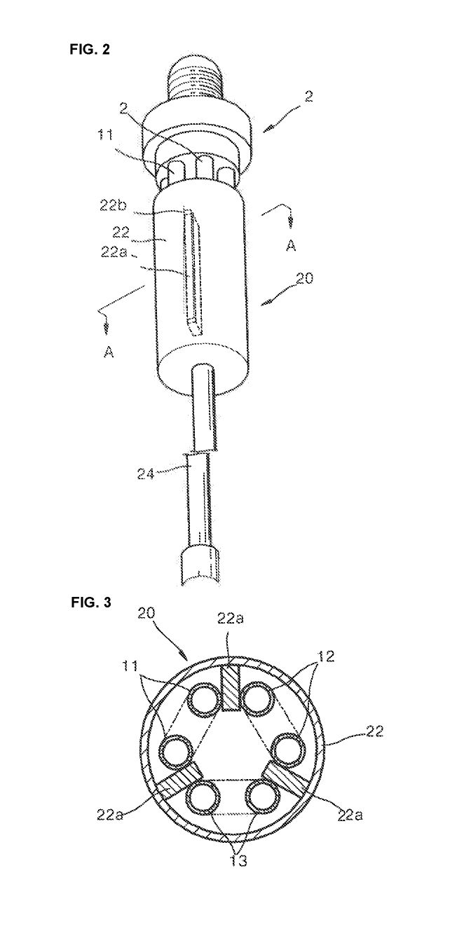

As the bulb insertion portion 22 is moved upward, the bulb 2 is inserted into the bulb insertion portion 22. In this case, as illustrated in FIG. 3, the three protrusions 22a are inserted into the three gaps 13, respectively. As the protrusions 22a are inserted into the gaps 13, the bulb 2 may be integrally fixed to the bulb insertion portion 22.

When the handle portion 24 is rotated counterclockwise, the bulb 2 is rotated together with the bulb insertion portion 22, such that the bulb 2 is separated from the socket.

Thereafter, a new bulb is inserted into the bulb insertion portion 22, the bulb insertion portion 22 is aligned with the socket, and then the handle portion 24 is rotated clockwise, such that the bulb 2 is coupled to the socket.

Therefore, the user more easily and conveniently replaces the bulb 2 positioned at a high place such as a ceiling.

In addition, the protrusions 22a are inserted into the gaps 13a of the bulb 2, and the bulb 2 is integrally fixed to the bulb insertion portion 22 and then separated from the socket by being rotated, and as a result, it is possible to prevent withdrawal or swaying of the bulb when replacing the bulb.

In addition, the bulb changer 20 is easily manufactured since the structure of the bulb changer 20 is comparatively simple.

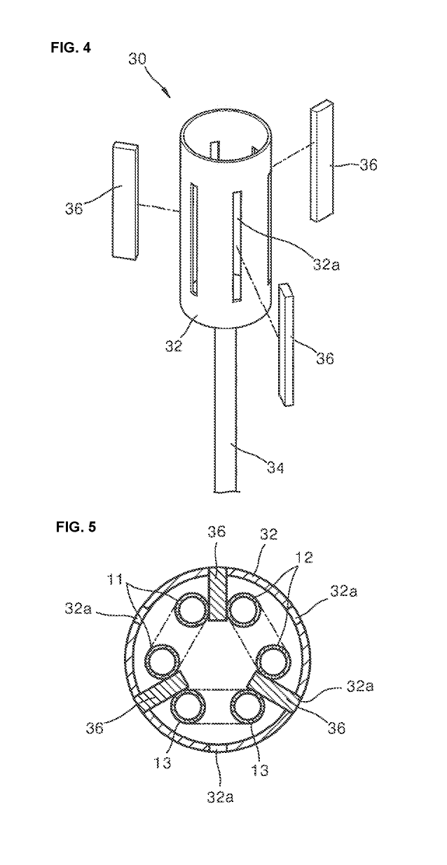

Referring to FIGS. 4 and 5, a bulb changer 30 according to a second exemplary embodiment of the present invention differs from the bulb changer according to the first exemplary embodiment in that the bulb changer 30 includes a bulb insertion portion 32 and a handle portion 34, and the bulb insertion portion 32 includes a plurality of slit holes 32a and protrusions 36 coupled to the slit holes 32a, and hereinafter, the difference will be described in detail.

The present exemplary embodiment describes an example in which the bulb 2 has three glass tubes, that is, first, second, and third glass tubes 11, 12, and 13 formed to be bent in a U shape, and the bulb 2 is a 3-tube bulb in which the first, second, and third glass tubes 11, 12, and 13 are disposed in a triangular shape. In the case in which the bulb 2 is the 3-tube bulb, the three gaps 13a are formed between the three glass tubes, that is, the first, second, and third glass tubes 11, 12, and 13. However, the present invention is not limited thereto, and the bulb 2 may of course have two or less glass tubes or four or more glass tubes. The bulb 2 is coupled to the socket by a threaded engagement, such that the bulb 2 is separated from the socket when the bulb 2 is rotated counterclockwise, and the bulb 2 is coupled to the socket when the bulb 2 is rotated clockwise.

The bulb insertion portion 32 is formed in a container shape opened at an upper side thereof so that the bulb 2 is inserted into the bulb insertion portion 32. A cross-sectional area of the bulb insertion portion 32 is increased upward toward the bulb 2 so that the bulb 2 is easily inserted into the bulb insertion portion 32. However, the present invention is not limited thereto, and the bulb insertion portion 32 may be formed in a cylindrical shape having a constant cross-sectional area. An example in which the bulb insertion portion 32 is made of a plastic material will be described.

The plurality of slit holes 32a is positioned in a lateral surface of the bulb insertion portion 32 so as to be spaced apart from one another at predetermined intervals in the circumferential direction. The slit hole 32a is elongated in the up and down direction. The number of slit holes 32a corresponds to the number of gaps 13a of the bulb 2, or the number of slit holes 32a is smaller than the number of gaps 13a. The present exemplary embodiment describes an example in which the slit holes 32a are formed to correspond to the number of gaps 13a of the bulb 2. That is, an example in which a total of six slit holes 32a are formed in the inner surface of the bulb insertion portion 32 so as to be spaced apart from one another at an interval of 60 degrees in the circumferential direction will be described.

The protrusions 26 are coupled to the plurality of slit holes 32a. In the present exemplary embodiment, since, for example, the bulb 2 is the 3-tube bulb and has the three gaps 13a, an example in which the three protrusions 36 are provided to be inserted into the three slit holes 32a among the six slit holes 32a will be described. The three protrusions 36 are disposed to be spaced apart from one another at an interval of 120 degrees in the circumferential direction. However, the present invention is not limited thereto, and the protrusions 36 may be coupled to all of the plurality of slit holes 32a, or may be fixedly coupled to at least some of the plurality of slit holes 32a. The number of protrusions 36 and the positions of the protrusions 36 may be determined in accordance with the shape of the bulb 2, and the number of protrusions 36 and the positions of the protrusions 36 may be selected by the user.

The protrusions 36 are formed in a shape corresponding to the plurality of slit holes 32a. An example in which the protrusion 36 is formed in a flat plate shape elongated in the up and down direction will be described. However, the present invention is not limited thereto, and the protrusion 36 may have a catching projection (not illustrated) so that the catching projection is caught by an outer surface of the bulb insertion portion 32 after the protrusion 36 is coupled to the slit hole 32a.

Meanwhile, in a case in which the bulb 2 is a 4-tube bulb having four glass tubes, the protrusions 36 may be coupled only to the two slit holes 32a which are spaced apart from each other at an interval of 180 degrees among the slit holes 32a. Therefore, the bulb 2 may be replaced in a state in which the protrusions 36 are inserted between the two glass tubes among the four glass tubes.

In the case of the bulb changer 30 according to the second exemplary embodiment which is configured as described above, the number of protrusions 36 and the positions of the protrusions 36 may be selectively determined by the user in accordance with the shape of the bulb 2, such that the limitation to the specifications of the bulb 2 is reduced, and the bulb changer 30 may be more easily used.

In addition, the bulb insertion portion 32 is made of a plastic material, but the protrusion 36 is made of an elastic member such as rubber, such that damage is prevented when the protrusion 36 comes into contact with the bulb 2, and the protrusion 36 is easily inserted into the gap 13a of the bulb 2.

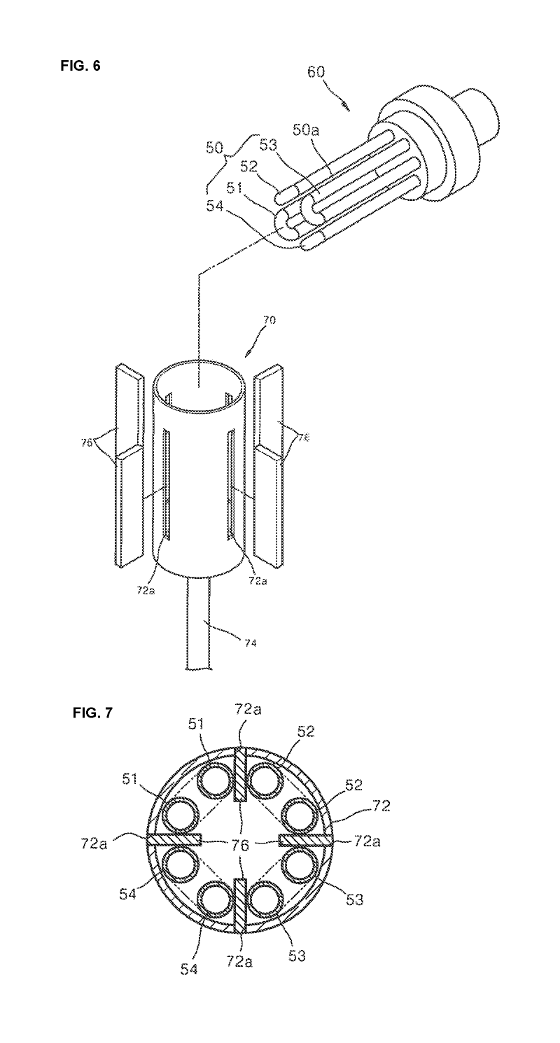

Referring to FIGS. 6 and 7, a bulb changer 70 according to a third exemplary embodiment of the present invention differs from the bulb changer according to the second exemplary embodiment in that the bulb changer 70 is a tool for replacing a 4-tube bulb having four glass tubes 50, and hereinafter, the difference will be described in detail.

The bulb changer 70 includes a bulb insertion portion 72 and a handle portion 74, and the bulb insertion portion 32 includes a plurality of slit holes 72a and protrusions 76 coupled to the slit holes 72a.

The bulb 60 has four glass tubes, that is, first, second, third, and fourth glass tubes 51, 52, 53, and 54 formed to be bent in a U shape, and the bulb 60 is a four-tube bulb in which the first, second, third, and fourth glass tubes 51, 52, 53, and 54 are disposed in a quadrangular shape. In the case in which the bulb 60 is the 4-tube bulb, a total of four gaps 50a are formed between the four glass tubes, that is, the first, second, third, and fourth glass tubes 51, 52, 53, and 54. The bulb 60 is coupled to the socket by a threaded engagement, such that the bulb 60 is separated from the socket when the bulb 60 is rotated counterclockwise, and the bulb 60 is coupled to the socket when the bulb 60 is rotated clockwise.

The bulb insertion portion 72 is formed in a container shape opened at an upper side thereof so that the bulb 60 is inserted into the bulb insertion portion 72. A cross-sectional area of the bulb insertion portion 72 is increased upward toward the bulb 60 so that the bulb 60 is easily inserted into the bulb insertion portion 72. However, the present invention is not limited thereto, and the bulb insertion portion 72 may be formed in a cylindrical shape having a constant cross-sectional area. An example in which the bulb insertion portion 72 is made of a plastic material will be described.

The plurality of slit holes 72a is positioned in a lateral surface of the bulb insertion portion 72 so as to be spaced apart from one another at predetermined intervals in the circumferential direction. The slit hole 72a is elongated in the up and down direction. The four slit holes 72a are formed in the inner surface of the bulb insertion portion 32 so as to be spaced apart from one another at an interval of 90 degrees in the circumferential direction. However, the present invention is not limited thereto, and in addition to the four slit holes, additional slit holes, which are spaced apart from one another at an interval of 60 degrees, are formed in the circumferential direction, such that the protrusions 76 may of course be inserted into the additional silt holes to replace the 3-tube bulb.

An example in which the protrusions 76 are detachably coupled to only some of the plurality of slit holes 72a will be described.

In the present exemplary embodiment, since, for example, the bulb 60 is the 4-tube bulb and has the four gaps 50a, an example in which the four protrusions 76 are provided to be inserted into the four slit holes 72a will be described. The four protrusions 76 are disposed to be spaced apart from one another at an interval of 90 degrees in the circumferential direction. However, the present invention is not limited thereto, and the protrusions 76 may be fixedly coupled to at least some of the plurality of slit holes 72a. The number of protrusions 76 and the positions of the protrusions 76 may be determined in accordance with the shape of the bulb 60, and the number of protrusions 76 and the positions of the protrusions 76 may be selected by the user.

The protrusions 76 are formed in a shape corresponding to the plurality of slit holes 72a. An example in which the protrusion 76 is formed in a flat plate shape elongated in the up and down direction will be described. However, the present invention is not limited thereto, and the protrusions 76 may have catching projections (not illustrated) so that the catching projections are caught by an outer surface of the bulb insertion portion 72 after the protrusions 76 are coupled to the plurality of slit holes 72a.

In the case of the bulb changer 70 according to the third exemplary embodiment which is configured as described above, the number of protrusions 76 and the positions of the protrusions 76 may be selectively determined by the user in accordance with the shape of the bulb 60 and a degree to which the bulb 60 is fixed, such that the limitation to the specifications of the bulb 60 is reduced, and the bulb changer may be more easily used.

In addition, the bulb insertion portion 72 is made of a plastic material, but the protrusion 76 may be manufactured by using an elastic member such as rubber, such that damage is prevented when the protrusion 76 comes into contact with the bulb 60, and the protrusion 76 is easily inserted into the gap 13a of the bulb 60.

Meanwhile, the present invention is not limited to the exemplary embodiment, the bulb changer 70 may include a plurality of bulb insertion portions detachably coupled to a single handle portion, and the plurality of bulb insertion portion has slit holes which are different in number and position from one another, such that one bulb insertion portion is selected among the plurality of bulb insertion portions in accordance with the shape of the bulb to be replaced, and one bulb insertion portion may be coupled to the handle portion and then used.

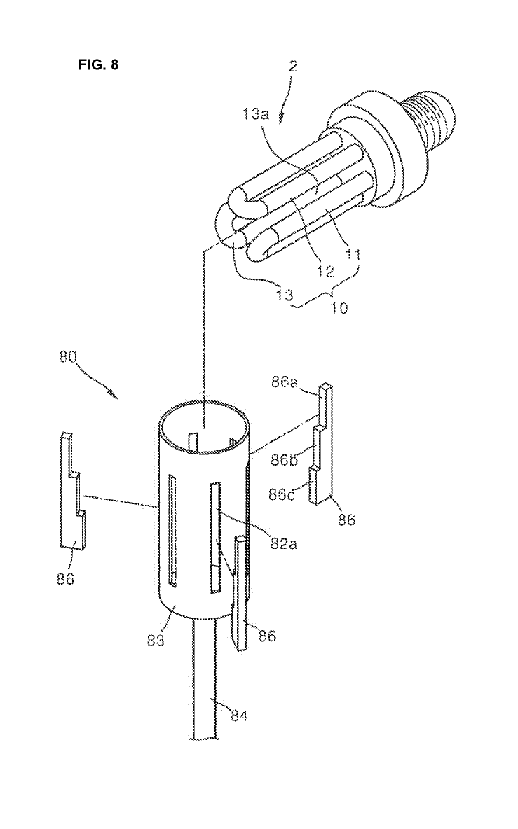

Referring to FIG. 8, a bulb changer 80 according to a fourth exemplary embodiment of the present invention differs from the bulb changer according to the second exemplary embodiment in that the bulb changer 80 includes a bulb insertion portion 82 and a handle portion 84, the bulb insertion portion 82 includes a plurality of slit holes 82a and protrusions 86 coupled to the slit holes 82a, and the protrusions 86 each have two or more portions having different protruding heights toward an interior of the bulb insertion portion 82, and hereinafter, the difference will be described in detail.

The protrusion 86 is formed in the form of a stair so that a protruding height of the protrusion 86 is decreased upward. The present exemplary embodiment describes an example in which three stepped portions, that is, first, second, and third stepped portions 86a, 86b, and 86c are formed. However, the present invention is not limited thereto, and the protrusion 86 is formed to be inclined so that the protruding height of the protrusion 86 is decreased upward.

In the case of the bulb changer 80 which is configured as described above, when the bulb 10 is inserted into the bulb insertion portion 82, a length of the protrusion 86 which is inserted into the bulb 10 varies in accordance with a size of the bulb 10. That is, only the first stepped portion 86a of the protrusion 86 may be inserted into the gap 13a in a case in which the size of the bulb is very large and the gaps 13a between the glass tubes 11, 12, and 13 of the bulb 10 are small. When only the first stepped portion 86a of the protrusion 86 is inserted into the gap 13a, the bulb insertion portion 82 is rotated in a state in which the bulb 10 is inserted into only a part of the bulb insertion portion 82, thereby separating the bulb 10. Meanwhile, all of the first to third stepped portions 86a to 86c of the protrusion 86 may be inserted into the gap 13a in a case in which the size of the bulb 10 is small and the gap 13a between the glass tubes of the bulb 10 is comparatively large. Therefore, the protrusion 86 may be inserted into the bulb regardless of the size of the bulb or the size of the gap 13a.

While the present invention has been described with reference to the exemplary embodiment depicted in the drawings, the exemplary embodiment is described just for illustration, and those skilled in the art will understand that various modifications of the exemplary embodiment and any other exemplary embodiment equivalent thereto are available. Accordingly, the true technical protection scope of the present invention should be determined by the technical spirit of the appended claims.

1. A bulb changer for replacing a bulb which is installed on a ceiling and has a plurality of glass tubes with gaps therebetween, the bulb changer comprising:
a bulb insertion portion which is formed in a container shape opened at an upper side thereof so that the bulb is inserted into the bulb insertion portion, in which the bulb insertion portion has protrusions that protrude to be inserted into the gaps of the bulb; and
a handle portion which is connected to a lower portion of the bulb insertion portion and elongated in an up and down direction so that a user holds and rotates the handle portion,
wherein a plurality of slit holes, which is elongated in the up and down direction, is formed in a lateral surface of the bulb insertion portion so as to be spaced apart from one another at predetermined intervals in a circumferential direction, and the protrusions are coupled to the plurality of slit holes.

2. A bulb changer for replacing a bulb which is installed on a ceiling and has a plurality of glass tubes with gaps therebetween, the bulb changer comprising:
a bulb insertion portion which is formed in a container shape opened at an upper side thereof so that the bulb is inserted into the bulb insertion portion, in which the bulb insertion portion has protrusions that protrude to be inserted into the gaps of the bulb; and
a handle portion which is connected to a lower portion of the bulb insertion portion and elongated in an up and down direction so that a user holds and rotates the handle portion,
wherein a plurality of slit holes, which is elongated in the up and down direction, is formed in a lateral surface of the bulb insertion portion so as to be spaced apart from one another at predetermined intervals in a circumferential direction, and the protrusions are detachably coupled to at least some of the plurality of slit holes.

3. The bulb changer of claim 1, wherein the protrusion is made of an elastic member.

4. The bulb changer of claim 1, wherein the bulb has the plurality of U-shaped glass tubes which are disposed in a polygonal shape so as to be spaced apart from one another by the gap.

5. A bulb changer for replacing a bulb which is installed on a ceiling and has a plurality of glass tubes with gaps therebetween, the bulb changer comprising:
a bulb insertion portion which is formed in a container shape opened at an upper side thereof so that the bulb is inserted into the bulb insertion portion, in which the bulb insertion portion has protrusions that protrude to be inserted into the gaps of the bulb; and
a handle portion which is connected to a lower portion of the bulb insertion portion and elongated in an up and down direction so that a user holds and rotates the handle portion,
wherein the protrusion has two or more portions having different protruding heights toward an interior of the bulb insertion portion.

6. The bulb changer of claim 5, wherein the protrusion is formed in the form of a stair so that a protruding height of the protrusion is decreased upward.

7. The bulb changer of claim 2, wherein the protrusion is made of an elastic member.

8. The bulb changer of claim 2, wherein the bulb has the plurality of U-shaped glass tubes which are disposed in a polygonal shape so as to be spaced apart from one another by the gap.
